(19) United States
(12) Patent Application Publication
(10) Pub. No.: US 2007/0082937 A1
(43) Pub. Date: Apr. 12, 2007

(54) Anti cancer combinations comprising a cox-2 inhibitor

(75) Inventors: Bruce Charles Baguley, Auckland (NZ); James William Paxton, Auckland (NZ); Liang-Chuan Steve Wang, Auckland (NZ); Philip Kestell, Auckland (NZ); Lai-Ming Ching, Auckland (NZ)

Correspondence Address: NIXON & VANDERHYE, PC, 901 NORTH GLEBE ROAD, 11TH FLOOR, ARLINGTON, VA, 22203, US

(73) Assignee: Cancer Research Technology Limited, London, ENG (GB)

(21) Appl. No.: 10/572,304

(22) PCT Filed: Sep. 2, 2004
(86) PCT No.: PCT/GB04/03749

§ 371 Date: Jul. 24, 2006

(30) Foreign Application Priority Data
Sep. 19, 2003 (GB) 0321999.5

(51) Int. Cl. A01N 43/50

(52) U.S. Cl. 514/386

(57) ABSTRACT

The present invention relates to synergistic combinations of the compounds of formula (I) such as compounds of the xanthenone acetic acid class such as 5,6dimethylxanthenone-4-acetic acid (DMXAA) and a selective COX-2 inhibitor, in particular rofecoxib, which have anti-tumour activity. More particularly, the invention is concerned with the use of such combinations in the treatment of cancer and pharmaceutical formulations containing said combinations.

### FIELD OF THE INVENTION

The present invention relates to treatment of neoplastic growth.

In particular the present invention relates to synergistic combinations of the compounds of the class having the formula (I) as defined below, for example compounds of the xanthenone acetic acid class having the formula (II) as defined below, such as 5,6-dimethylxanthenone-4-acetic acid (DMXAA) and specific non-steroidal anti-inflammatory drugs capable of selectively inhibiting cyclo-oxygenase-2 (COX-2), in particular etoricoxib, parecoxib, celecoxib, valdecoxib, or rofecoxib (also known as Arcoxia™, Dynastat™, Celebrex™, Bextra™ and Vioxx™, respectively) for the treatment of neoplastic growth.

### BACKGROUND OF THE INVENTION

5,6-dimethylxanthenone-4-acetic acid (DMXAA) is represented by the following formula:

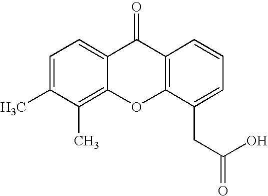

Phase I clinical trials of DMXAA have recently been completed (New Zealand, Mount Vernon Hospital, Bradford Royal Infirmary and in Auckland, New Zealand organised by Cancer Research UK). Using a dynamic magnetic resonance imaging (MRI) system, it was possible to demonstrate that DMXAA can induce a significant reduction in tumour blood flow at well-tolerated doses. These trials confirmed that DMXAA is one of the first antivascular agents for which activity (damage to blood vessels in tumour tissue and irreversibly inhibit blood supply to the tumour tissue) has been documented in human tumours. These findings are in agreement with pre-clinical studies using tumours or human tumour xenografts which showed that its antivascular activity produced prolonged inhibition of tumour blood flow leading to extensive regions of haemorrhagic necrosis.

Conventional non-steroidal anti-inflammatory drugs (NSAIDs) share the capacity to suppress the signs and symptoms of inflammation. Many also exert antipyretic and analgesic effects. The major target molecules of NSAIDs are cyclooxygenases (COXs) which catalyse the rate-limiting step of prostaglandin biosynthesis.

Two isoenzymes of COX have been identified: COX-1 and COX-2.

Whereas COX-1 is expressed constitutively in most tissues and in general is responsible for tissue homeostasis, COX-2 is inducible and plays an important role in inflammation and tumourigenesis.

Selective inhibition of COX-2 can result in effective relief of pain and inflammation, but COX-1 inhibitors can lead to unacceptable gastrointestinal side effects including diarrhea, bloating, heartburn, upset stomach (dyspepsia) and ulcers.

Salicylate is the major anti-inflammatory metabolite of aspirin, the original NSAID. Aspirin irreversibly acetylates and blocks the enzyme platelet cyclooxygenase. Salicylate is a selective COX-1 inhibitor.

Other NSAIDS are reversible inhibitors and selectivity for COX-1 and COX-2 is variable for many of the conventional NSAIDs.

Simple reversible inhibitors such as ibuprofen and sulindac can inhibit both COX-2 and COX-1 to approximately the same extent.

However, reversible and at the same time highly selective COX-2 inhibitors such as etoricoxib, parecoxib, celecoxib, valdecoxib or rofecoxib (also known as Arcoxia™, Dynastat™, Celebrex™, Bextra™ and Vioxx™, respectively) are now available.

Celebrex™ is used for relief of osteoarthritis (the arthritis caused by age-related “wear and tear” on bones and joints), relief of rheumatoid arthritis in adults, management of acute pain in adults (such as short term pain after a dental or surgical operation), treatment of menstrual pain and reducing the number of colon and rectum growths (colorectal polyps) in patients with Familial Adenomatous Polyposis (FAP). FAP is an inherited disease in which the rectum and colon are covered with many polyps. Celebrex™ is used along with the usual care for FAP patients such as surgery and examination of the rectum and colon. Celebrex™ has not been shown to reduce cancer that may occur with FAP.

Generally, Vioxx™ is used for signs and symptoms of osteoarthritis, acute pain in adults and painfull menstrual cycles.

Thus, there is a need to develop a therapy for the treatment of neoplastic growth which is characterised with greater selectivity and effectiveness in the treatment, accompanied with a reduction in undesirable side effects.

### SUMMARY OF THE INVENTION

It has now surprisingly been found that by administering, simultaneously, separately or sequentially, compounds having the formula (I) as defined below and an NSAID which is capable of selectively inhibiting cyclo-oxygenase-2 (COX-2) at concentrations which are capable of enhancing the effectiveness of compounds of formula (I), potentiation of the anti-tumour activity of compounds having formula (I) as defined above can be achieved.

In particular, it has been found that co-administration of compounds of formula (I) as defined below, such as DMXAA, with a selective COX-2 inhibitor, such as rofecoxib can provide a therapeutic gain against sub-cutaneously established (60 mm³) colon 38 tumour fragments at concentrations which are capable of enhancing the effectiveness of compounds of formula (I), as defined below.

### DESCRIPTION OF THE INVENTION

According to a first aspect, the present invention provides a method for modulating neoplastic growth, which comprises administering to a mammal, including a human, in need of treatment an effective amount of a compound of the formula (I): 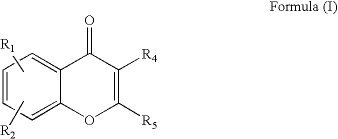
or a pharmaceutically acceptable salt or ester thereof and simultaneously, separately or sequentially administering an effective amount of a selective COX-2 inhibitor which is capable of enhancing the effectiveness of compounds of formula (I) as defined above to function as an anti-tumour agent in said mammal;
wherein:
(a) R₄ and R₅ together with the carbon atoms to which they are joined, form a 6-membered aromatic ring having a substituent —R₃ and a radical —(B)—COOH where B is a linear or branched substituted or unsubstituted C₁-C₆ alkyl radical, which is saturated or ethylenically unsaturated, and wherein R₁, R₂ and R₃ are each independently selected from the group consisting of H, C₁-C₆ alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy; or
(b) one of R₄ and R₅ is H or a phenyl radical, and the other of R₄ and R₅ is H or a phenyl radical which may optionally be substituted, thienyl, furyl, naphthyl, a C₁-C₆ alkyl, cycloalkyl, or aralkyl radical; R₁ is H or a C₁-C₆ alkyl or C₁-C₆ alkoxy radical; R₂ is the radical —(B)—COOH where B is a linear or branched substituted or unsubstituted C₁-C₆ alkyl radical, which is saturated or ethylenically unsaturated.

In a second aspect, the present invention provides a method for modulating neoplastic growth, which comprises administering to a mammal, including a human, in need of treatment an effective amount of a compound of formula (I): 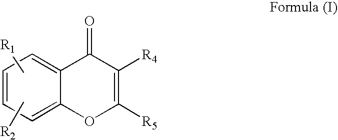
or a pharmaceutically acceptable salt or ester thereof and simultaneously, separately or sequentially administering an effective amount of a selective COX-2 inhibitor, wherein said effective amount of said inhibitor is in the range of greater than 5 mg/kg to 200 mg/kg, e.g. from 50-200 mg/kg, which enhances the effectiveness of the compound of formula (I) as defined above to function as an anti-tumour agent in said mammal;
wherein:
(a) R₄ and R₅ together with the carbon atoms to which they are joined, form a 6-membered aromatic ring having a substituent —R₃ and a radical —(B)—COOH where B is a linear or branched substituted or unsubstituted C₁-C₆ alkyl radical, which is saturated or ethylenically unsaturated, and wherein R₁, R₂ and R₃ are each independently selected from the group consisting of H, C₁-C₆ alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy; or
(b) one of R₄ and R₅ is H or a phenyl radical, and the other of R₄ and R₅ is H or a phenyl radical which may optionally be substituted, thienyl, furyl, naphthyl, a C₁-C₆ alkyl, cycloalkyl, or aralkyl radical; R₁ is H or a C₁-C₆ alkyl or C₁-C₆ alkoxy radical; R₂ is the radical —(B)—COOH where B is a linear or branched substituted or unsubstituted C₁-C₆ alkyl radical, which is saturated or ethylenically unsaturated.

Where the radical —(B)—COOH is a substituted C₁-C₆ alkyl radical, the substituents may be alkyl, for example methyl, ethyl, propyl or isopropyl, or halide such as fluoro, chloro or bromo groups. A particularly preferred substituent is methyl.

In one embodiment of the invention, the compound of the formula (I) as defined above is a compound of the formula (II), 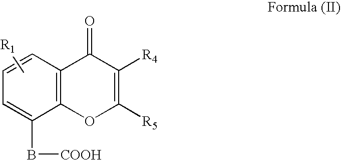
where R₁, R₄, R₅ and B are as defined above for formula (I) in part (b).

In a preferred embodiment of the invention, the compound of formula (I) as defined above is a compound of the formula (III): 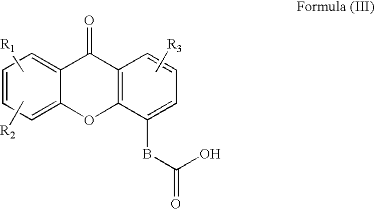
wherein R₁, R₂ and R₃ are each independently selected from the group consisting of H, C₁-C₆ alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy;

wherein B is as defined for formula (I) above;

and wherein in each of the carbocyclic aromatic rings in formula (I), up to two of the methine (—CH═) groups may be replaced by an aza (—N═) group;

and wherein any two of R₁, R₂ and R₃ may additionally together represent the group —CH═CH—CH═CH—, such that this group, together with the carbon or nitrogen atoms to which it is attached, forms a fused 6 membered aromatic ring.

Preferably, the compound of formula (III) is a compound of the formula (IV): 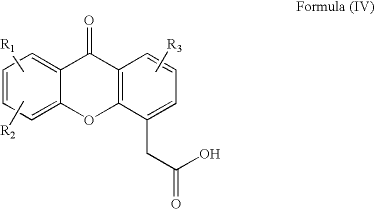
wherein R, R₁, R₂ and R₃ are as defined for formula (III).

In a preferred embodiment of the compound of formula (IV), R₂ is H, one of R₁ and R₃ is selected from the group consisting of C₁-C₆ alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy, and the other of R₁ and R₃ is H.

Preferably, the compound of formula (IV) is of the formula (V): 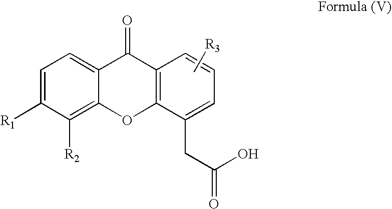
wherein R, R₁, R₂ and R₃ are as defined for formula IV.

Most preferably, the compound of formula (IV) is 5,6-dimethylxanthenone 4 acetic acid (DMXAA)

As used herein the term “selective COX-2 inhibitor” defines an NSAID which is capable of specifically selecting and inhibiting one of the isoenzyme members of the cyclooxygenases which catalyse the rate-limiting step of prostaglandin biosynthesis, namely specifically inhibiting cyclooxygenase-2 or COX-2. It is within the scope of the present invention that a selective COX-2 inhibitor may be chosen from the group comprising etoricoxib, parecoxib, celecoxib, valdecoxib or rofecoxib (also known as Arcoxia™, Dynastat™, Celebrex™, Bextra™ and Vioxx™, respectively).

The term “enhance the effectiveness” refers to an amount of a selective COX-2 inhibitor which can increase, promote, upregulate, stimulate, higher or generally enhance the capacity of the compound of formula (I) to act as a therapeutic agent or an anti-tumour agent in a mammal. In other words, in the context of the present invention, a selective COX-2 inhibitor can enhance the effectiveness of the compound of formula (I) to function as an anti-tumour agent in a mammal. Thus, the enhancement of the effectiveness of the compound of formula (I) in the mammal as caused by the selective COX-2 inhibitor may lead to a synergistic, co-operative or additive pharmaceutical effect.

As used herein the term “function as an anti-tumour agent” defines a selective COX-2 inhibitor which can increase, promote, upregulate, stimulate, higher or generally enhance the capacity of the compound of formula (I) to act as a therapeutic agent in the treatment of neoplastic growth in a mammal.

Different mechanisms can be envisaged by which a selective COX-2 inhibitor may enhance the effectiveness of the compound of formula (I) to function as an anti-tumour agent.

It has been suggested that one of the mechanisms by which a selective COX-2 inhibitor may enhance the effectiveness of the compound of formula (I) to function as an anti-tumour agent is by increasing the plasma pharmacokinetics of the compound of formula (I) as defined above in the mammal. In the context of the present invention, the term “plasma pharmacokinetics” defines the capacity of a selective COX-2 inhibitor to affect the plasma (or tissue) concentration of the compound of formula (I) by altering the absorption, distribution, excretion or metabolism. Different methods of determining the plasma concentration of the compound of formula (I) in the mammal in the presence or absence of the selective COX-2 inhibitor will be known to those of skill in the art.

In another aspect, the present invention provides the use of a compound of formula (I) as defined above or a pharmaceutically acceptable salt or ester thereof for the manufacture of a medicament, for administration simultaneously, separately or sequentially with a unit dose of a selective cyclooxygenase-2 inhibitor compound, for the modulation of neoplastic growth, wherein said unit dose comprises said selective COX-2 inhibitor in an amount which enhances the effectiveness of the compound of formula (I) to function as an anti-tumour agent in the mammal.

In a further aspect, the present invention provides the use of a selective COX-2 inhibitor compound for the manufacture of a unit dose of a medicament, for simultaneous, separate or sequential administration with a compound of formula (I) as defined above or a pharmaceutically acceptable salt or ester thereof, for the modulation of neoplastic growth, wherein said unit dose comprises said selective-COX-2 inhibitor compound in an amount which enhances the effectiveness of DMXAA to function as an anti-tumour agent in a subject to be treated.

In a still further aspect, the present invention provides a combined preparation of a compound of formula (I) as defined above or a pharmaceutically acceptable salt or ester thereof and a selective COX-2 inhibitor compound for simultaneous, separate or sequential use, e.g. for modulation of neoplastic growth, wherein the compound of formula (I) or pharmaceutically acceptable salt or ester thereof and the selective COX-2 inhibitor compound are present in a potentiating ratio, and wherein said inhibitor compound is in an amount which enhances the effectiveness of the compound of formula (I) as defined above to function as an anti-tumour agent in a subject to which the combination is administered.

In a further aspect, there is provided a pharmaceutical formulation comprising a combination of a compound of formula (I) as defined above or a pharmaceutically acceptable salt or ester thereof and a selective COX-2 inhibitor compound and optionally one or more pharmaceutically acceptable carriers, excipients, diluents or adjuvants wherein a unit dose of said pharmaceutical formulation comprises said selective COX-2 inhibitor compound in an amount which enhances the effectiveness of the compound of formula (I) as defined above to function as an anti-tumour agent in a subject to be treated.

The invention further provides a process for the preparation of a pharmaceutical formulation which process comprises bringing into association a combination of a compound of formula (I) as defined above or a pharmaceutically acceptable salt or ester thereof and a selective COX-2 inhibitor compound and optionally one or more pharmaceutically acceptable carriers, excipients, diluents or adjuvants therefor in a unit dose in which said COX-2 inhibitor compound is in an amount which enhances the effectiveness of the compound of formula (I) to function as an anti-tumour agent in a subject to be treated.

Furthermore, there is also provided a kit comprising in combination for simultaneous, separate or sequential use in modulating neoplastic growth, a compound of formula (I) as defined above or a pharmaceutically acceptable salt or ester thereof and a selective COX-2 inhibitor compound, wherein said selective COX-2 inhibitor is provided in a unit dose comprising an amount of said inhibitor which enhances the effectiveness of the compound of formula (I) to function as an anti-tumour agent in a subject to be treated.

In the kit the compound of formula (I) or pharmacuetically acceptable salt or ester thereof may be present in a unit dose.

There is also provided a kit for simultaneous, separate or sequential use in modulating neoplastic growth, wherein the kit contains two components, e.g. formulations:
i) a first component comprising a compound of formula (I) e.g. DMXAA, or a pharmaceutically acceptable salt or ester thereof, and
ii) a second component comprising a selective COX-2 inhibitor,
   wherein said second component is provided in a unit dose comprising the selective COX-2 inhibitor in an amount which is least that required to enhance the effectiveness of the compound of formula (I) e.g. DMXAA, or a pharmaceutically acceptable salt or ester thereof to function as an anti-tumour agent in a subject to be treated.

In the kit the first component may be present in a unit dose.

In one embodiment the selective cylooxygenase-2 inhibitor may be selected from the group comprising etoricoxib, parecoxib, celecoxib, valdecoxib and rofecoxib. For example, the selective cylooxygenase-2 inhibitor may be rofecoxib (also known as Vioxx™).

In another embodiment, the pharmaceutical formulations as described herein may be administered to a patient while the patient is undergoing other forms of treatment. Accordingly, it is contemplated that the pharmaceutical formulations as described herein may be used in conjunction with another pharmaceutically beneficial entity. The other entity need not be administered by the same route. That other entity may be a drug such as steroids, corticosteroids, antibiotics, antiviral therapy, immunosuppresants and anti-inflammatories.

Preferably, the selective COX-2 inhibitor may enhance the effectiveness of the compound of formula (I) to treat neoplastic growth by at least 0.5%, 1%, 2.5%, 5%, 10%, 20%, 30%, 40% 50%, 60%, 70%, 80%, 90%, 100%, 110%, 120%, 130%, 140%, 150%, 200%, 250%, 300%, 350%, 400%, 450%, 500%, 550% or more compared to the effectiveness of the amount of the compound of formula (I) in the absence of a selective COX-2 inhibitor.

Without wishing to be bound by theory and as stated above, one of the mechanisms by which a selective COX-2 inhibitor may lead to an enhancement in the effectiveness of the compound of formula (I) to function as an anti-tumour agent is by the capacity of the selective COX-2 inhibitor to affect the plasma pharmacokinetics of the compound of formula (I) which may cause an increase in the bioavailability of the compound of formula (I).

Dosages and Formulations

The compound of formula (I) as defined above or pharmaceutically acceptable salt or ester thereof and the selective COX-2 inhibitor compound may be administered simultaneously, separately or sequentially. For example, the compound of formula (I) as defined above or pharmaceutically acceptable salt or ester thereof and the selective COX-2 inhibitor compound are administered within 6 hours, e.g. within 4 hours, such as within 2 hours of one another. In one embodiment the compound of formula (I) as defined above or pharmaceutically acceptable salt or ester thereof and the selective COX-2 inhibitor compound are administered simultaneously. For example, the two compounds may be administered simultaneously by infusion over 0.2 to 6 hours, for example 0.33 to 3 hours.

The pharmaceutically acceptable salt may, for example, be the sodium salt.

The term “selective COX-2 inhibitor” is used herein to indicate that the inhibitor as described herein has the capacity to specifically reduce, lower, suppress, thwart, inactivate, repress, diminish, block or generally inhibit the. catalytic activity of COX-2 enzymes. For example, the selective COX-2 inhibitor has the capacity to inhibit the function of COX-2 in catalysing the rate-limiting step of prostaglandin biosynthesis by at least 0.1%, 0.5%, 1%, 2%, 3%, 4%, 5%, 10%, 20%, 30%, 40%, 50%, 60%, 70%, 80%, 90%, 95%, 99% or 100%. The selective COX-2 inhibitor may be a reversible or an irreversible inhibitor. In one embodiment the selective COX-2 inhibitor is a reversible selective COX-2 inhibitor.

In one embodiment the compound of formula (I) or pharmaceutically acceptable salt or ester thereof and the selective COX-2 inhibitor compound are administered in a potentiating ratio.

The term ‘potentiating ratio’ is used herein to indicate that the compound of formula (I), as defined above, or pharmaceutically acceptable salt or ester thereof and the selective COX-2 inhibitor compound are present in a ratio such that the anti-tumour activity of the combination is greater than that of either the compound of formula (I) or the selective COX-2 inhibitor compound alone or of the additive activity that would be predicted for the combinations based on the activities of the individual components. Thus the individual components act synergistically or co-operatively in combination provided they are present in a potentiating ratio.

For example, a potentiating ratio, for a compound of formula (I), as defined above, or pharmaceutically acceptable salt or ester thereof and the selective COX-2 inhibitor which may be successfully used to treat cancer, is in the range 1:150 to 15:1, for example in the range of 1:125 to 13:1, e.g. in the range of 1:100 to 12:1, e.g. in the range of 1:75 to 10:1, e.g in the range of 1:50 to 5:1, e.g. in the range of 1:25 to 1:1, e.g. in the range of 1:15 to 1:1. In one embodiment, the potentiating ratio is in the range 1:10 to 1:1, e.g. approximately 1:6.

The compound of formula (I), e.g. DMXAA, may, for example, be administered (e.g. to man) for treatment of cancer in a dose in the range of 600 to 4900 mg/m², e.g. from 1200 to 3500 mg/m², e.g. from 2000 to 3000 mg/m², such as from 2250 to 2750 mg/m².

The selective COX-2 inhibitor such as rofecoxib (Vioxx™) may, for example, be administered (e.g. to man) for treatment of cancer in a dose in the range of greater than 5 and up to 1000 mg/60 kg, e.g. from 10-900 mg/60 kg, e.g. from 20-600 mg/60 kg, e.g. from 30 to 500 mg/60 kg, e.g. from 60 to 400 mg/60 kg of inhibitor, e.g. from 70 to 200 mg/60 kg, e.g. from 80 to 160 mg/60 kg, e.g. from 90 to 150 mg/60 kg, e.g. from range of 100 to 125 mg/60 kg, e.g. in the range of 110 to 140 mg/60 kg, for example 120 to 130 mg/60 kg.

As used in connection with the present invention, the term “mg/60 kg” refers to the amount of the stated compound per 60 kg of body weight of mammal, and “mg/m²” refers to the weight of the stated compound per square metre of surface area of the patient who is treated.

Those of skill in the art would be aware how to convert the administered dose units mg/kg to surface area (mg/m²). Each species has its own surface area conversion factor. For example the conversion factors used by the Federal Drugs Administration (FDA) are as follows: mouse=3, hamster=4.1, rat=6, Guinea pig=7.7, human=37 (Cancer Chemotherapy Research 1966, 50(4): 219). In order to be able to perform the conversion, multiply the conversion factor by the animal dose in mg/kg to obtain the dose in mg/m² for human dose equivalent.

Alternatively, when both height and weight of the patient to be treated are known, the body surface area may be calculated using Boyd's Formula of Body Surface Area (Boyd E., The growth of the surface area of the human body, University of Minnesota Press, 1935). It should be noted that calculations with weight alone are less accurate.

As stated above, according to a second aspect of the present invention there is provided a method for modulating neoplastic growth which comprises administering to a mammal, including a human, in need of treatment an effective amount of a compound of the formula (I) as defined above, or a pharmaceutically acceptable salt or ester thereof and simultaneously, separately or sequentially administering an effective amount of a selective COX-2 inhibitor, wherein said effective amount of said inhibitor is in the range of greater than 5 mg/60 kg and up to 1000 mg/60 kg, e.g. from 50-1000 mg/60 kg, which causes an enhancement in the effectiveness of the compound having the formula (I) to act as an ant-tumour agent in said mammal.

The amount of a combination of a compound of formula (I) as defined above, for example DMXAA, or a pharmaceutically acceptable salt or ester thereof and the selective COX-2 inhibitor compound required to be effective as an anti-tumour agent will vary depending on the mammal to be treated and will ultimately be determined by the medical practitioner. The factors to be considered include the route of administration and nature of the formulation, the mammal's bodyweight, age and general condition and the nature and severity of the disease to be treated.

Generally, a suitable effective dose of a selective COX-2 inhibitor to be used in combination with DMXAA for administration to man for treatment of cancer may be a dose which is substantially non-toxic to man but which at the same time has the capacity to enhance the effectiveness of the compound of formula (I) to act as an anti-cancer agent.

The amount of a combination of a combination of formula (I) or a or a pharmaceutically acceptable salt or ester thereof and a selective COX-2 inhibitor required to be effective as an anti-cancer agent will of course vary and is ultimately at the discretion of the medical practitioner. Different factors which may be considered include the route of administration and the nature of the formulation, the mammal's bodyweight, age and general condition and the nature and severity of disease to be treated.

Generally, a suitable effective dose of a combination of formula (I), e.g. DMXAA, or pharmaceutically acceptable salt or ester thereof and a selective COX-2 inhibitor for administration to man for treatment of cancer is in the range of 600 to 4900 mg/m² of a compound of formula (I) (e.g. DMXA) or pharmaceutically acceptable salt or ester thereof and greater than 5 mg/60 kg to 1000 mg/60 kg, e.g. from 10-900 mg/60 kg, of a selective COX-2 inhibitor such as rofecoxib (Vioxx™). For example, from 600 to 4900 mg/m² of a compound of formula (I) (e.g. DMXAA) or pharmaceutically acceptable salt or ester thereof and 20 to 700 mg/60 kg of an inhibitor such as rofecoxib, e.g. from 1200 to 3500 mg/m² of a compound of formula (I) (e.g. DMXAA) or pharmaceutically acceptable salt or ester thereof and 30 to 500 mg/60 kg of inhibitor, e.g. from 2000 to 3000 mg/m² of a compound of formula (I) (e.g. DMXAA) or pharmaceutically acceptable salt or ester thereof and 60 to 400 mg/60 kg of inhibitor, e.g. from 2250 to 2750 mg/m² of a compound of formula (I) (e.g. DMXAA) or pharmaceutically acceptable salt or ester thereof and 70 to 200 mg/60 kg of inhibitor, e.g. from 2250 to 2750 mg/m² of a compound of formula (I) (e.g. DMXAA) or pharmaceutically acceptable salt or ester thereof and 90 to 150 mg/60 kg of inhibitor. In one embodiment the dose is in the range of 2250 to 2750 mg/m² of a compound of formula (I) (e.g. DMXAA) or pharmaceutically acceptable salt or ester thereof and 100 to 150 mg/60 kg of inhibitor. In another embodiment the dose is in the range 2250 to 2750 mg/m² of a compound of formula (a) (e.g. DMXAA) or pharmaceutically acceptable salt or ester thereof and 110 to 140 mg/60 kg of inhibitor, for example 120 to 130 mg/60 kg of inhibitor.

The compound of formula (I) or the pharmaceutically acceptable salt or ester thereof and the selective COX-2 inhibitor compound are also referred to herein as the active ingredients.

The compound of formula (I) or pharmaceutically acceptable salt or ester thereof and the selective COX-2 inhibitor compound may be administered in any suitable form. For example, pharmaceutical formulations may comprise one or both of the active ingredients (that is, the compound of formula (I) or a pharmaceutically acceptable salt or ester thereof and/or the selective COX-2 inhibitor compound) optionally together with one or more pharmaceutically acceptable carriers, diluents, excipients or adjuvants therefor and optionally together with other therapeutic and/or prophylactic ingredients. The carriers, diluents, excipients or adjuvants must be acceptable in the sense of being compatible with the other ingredients of the formulation and not deleterious to the recipient thereof.

In one embodiment of the present invention a combination of a compound of formula (I) or a pharmaceutically acceptable salt or ester thereof with a selective COX-2 inhibitor compound and optionally one or more pharmaceutically acceptable carriers, excipients, diluents or adjuvants is presented as a pharmaceutical formulation.

Accordingly, in one embodiment of the invention there is provided a pharmaceutical formulation comprising a combination of compound of formula (I) or a pharmaceutically acceptable salt or ester thereof and a selective COX-2 inhibitor compound optionally in association with one or more pharmaceutically acceptable carriers, diluents, excipients or adjuvants therefor, wherein the selective COX-2 inhibitor compound is present in an amount which causes an enhancement in the effectiveness of the compound of formula (I) to act as an anti-cancer agent in a subject to which the combination is administered.

In another embodiment of the invention, a pharmaceutical formulation may comprise one active ingredient (i.e. the compound of formula (I) or a pharmaceutically acceptable salt or ester thereof) optionally together with one or more pharmaceutically acceptable carriers, diluents, excipients or adjuvants therefor, while another pharmaceutical formulation may comprise the other active ingredient (i.e. the selective COX-2 inhibitor) optionally together with one or more pharmaceutically acceptable carriers, diluents, excipients or adjuvants therefor. When the active ingredients are present in separate pharmaceutical formulations, the formulations may be administered simultaneously, separately or sequentially such that the selective COX-2 inhibitor which is a component of one of the pharmaceutical formulations is able to enhance the effectiveness of the compound of formula (I), e.g. DMXAA, or a pharmaceutically acceptable salt or ester thereof which is a component of another pharmaceutical formulation.

There is also provided a process for the preparation of a pharmaceutical formulation which process comprises bringing into association a combination of a compound of formula (I) e.g. DMXAA, or a pharmaceutically acceptable salt or ester thereof and a selective COX-2 inhibitor compound optionally with one or more pharmaceutically acceptable carriers, diluents, excipients or adjuvants, wherein said selective COX-2 inhibitor compound is present in said pharmaceutical formulation in an amount which causes an enhancement in the effectiveness of compound of formula (I) e.g. DMXAA, to act as an anti-cancer agent in a subject to which the pharmaceutical formulation is administered.

It is within the scope of the present invention that the pharmaceutical formulations as described herein may be administered while the patient is undergoing other forms of treatment. Accordingly, it is contemplated that the pharmaceutically active ingredients as described herein may be used in conjunction with another pharmaceutically beneficial entity. The other entity need not be administered by the same route. That other entity may be a drug such as steroids, corticosteroids, antibiotics, antiviral therapy, immunosuppresants and anti-inflammatories. Preferably, the other entities would not adversely affect the ability of the selective COX-2 to increase the plasma concentration of the compound of formula (I), e.g. DMXAA, as described in this document.

Route of Administration.

The pharmaceutical formulations as described herein can be administered by standard routes. These include but are not limited to: oral, rectal, ophthalmic (including intravitreal or intracameral), nasal, topical (including buccal and sublingual), intrauterine, vaginal or parenteral (including subcutaneous, intraperitoneal, intramuscular, intravenous, intradermal, intracranial, intratracheal, and epidural), transdermal, intracranial, intracerebroventricular, intracerebral, intravaginal, or intrauterine. Other routes of administration include transmucosal, transurethral or intraurethral. In some applications it may be desirable for the active ingredient(s) to cross the Blood brain barrier (BBB).

Different drug delivery systems can be used to administer the pharmaceutical formulations, depending upon the desired route of administration. Drug delivery systems are described, for example, by Langer, R. (Science, 249: 1527-1533 (1990)).

Different Routes of Administration for Drug Delivers will now be Considered in Greater Detail.

The term “administered” includes delivery by any route known in the art.

The pharmaceutical formulations described herein may comprise a suitable pharmaceutical excipient, diluent, adjuvant or carrier selected with regard to the intended route of administration and standard pharmaceutical practice.

For example, the pharmaceutical formulations described herein may be administered (e.g. orally, topically or directly into the blood stream) in the form of tablets, capsules, ovules, elixirs, solutions or suspensions, which may contain flavouring or colouring agents, for immediate-, delayed-, modified-, sustained-, pulsed- or controlled-release applications.

The tablets may contain excipients such as microcrystalline cellulose, lactose, sodium citrate, calcium carbonate, dibasic calcium phosphate and glycine, disintegrants such as starch (preferably corn, potato or tapioca starch), sodium starch glycollate, croscarmellose sodium and certain complex silicates, and granulation binders such as polyvinylpyrrolidone, hydroxypropylmethylcellulose (HPMC), hydroxypropylcellulose (HPC), sucrose, gelatin and acacia. Additionally, lubricating agents such as magnesium stearate, stearic acid, glyceryl behenate and talc may be included.

For example, tablets may contain excipients such as lactose, starch, cellulose, milk sugar or high molecular weight polyethylene glycols. For aqueous suspensions and/or elixirs, the active ingredients may be combined with various sweetening or flavouring agents, with colouring matter or dyes, with emulsifying and/or suspending agents and with diluents such as water, ethanol, propylene glycol and glycerin, and combinations thereof.

Formulations suitable for parenteral administration include aqueous and non-aqueous sterile injection solutions which may contain anti-oxidants, buffers, bacteriostats and solutes which render the formulation isotonic with the blood of the intended recipient; and aqueous and non-aqueous sterile suspensions which may include suspending agents and thickening agents. The formulations may be presented in unit-dose or multi-dose containers, for example, sealed ampules and vials, and may be stored in a freeze-dried (lyophilized) condition requiring only the addition of the sterile liquid carrier, for example, water for injections, immediately prior to use. Extemporaneous injection solutions and suspensions may be prepared from sterile tablets of the kind described above.

The formulations as described in this document may conveniently be presented in unit dosage form and may be prepared by conventional pharmaceutical techniques. Such techniques include the step of bringing into association:
i) the compound of formula (I) or a pharmaceutically acceptable salt or ester thereof and/or a selective COX-2 inhibitor compound, and
ii) pharmaceutical carrier(s), diluent(s), adjuvant(s) or excipient(s).

For example, the formulations may be prepared by uniformly and intimately bringing into association the pharmaceutically active ingredients with liquid carriers or finely divided solid carriers carrier(s), diluent(s), adjuvant(s) or excipient(s) or both, and then, if necessary, shaping the product.

In addition, pharmaceutical formulations may be incorporated into biodegradable polymers allowing for sustained release of the active ingredient(s), the polymers being implanted in the vicinity of where drug delivery is desired, for example, at the site of a tumor or implanted so that the formulation is slowly released systemically. Biodegradable polymers and their use are described, for example, in detail in Brem et al, 1991 J. Neurosurg 74: 441-446. Osmotic minipumps may also be used to provide controlled delivery of high concentrations of the active ingredient(s) through cannulae to the site of interest, such as directly into a solid tumour growth.

Unit dosage formulations may contain a daily dose or unit, daily sub-dose, or an appropriate fraction thereof, of the administered active ingredient. It should be understood that the daily dose or unit, the daily sub-dose or the appropriate fraction thereof would be determined by the medical practitioner. It should be understood that in addition to the ingredients, particularly mentioned above, formulations according to the present invention may include other agents conventional in the art having regard to the type of formulation in question.

Capsules, tablets and pills for oral administration to a patient may be provided with an enteric coating comprising, for example, Eudragit™ “s”, Eudragit™ “L”, cellulose acetate, cellulose acetate phthalate or hydroxypropylmethyl cellulose.

In one embodiment the pharmaceutical formulations are adapted for parenteral administration, for example, intravenous administration. For example, the active ingredients may be administered intravenously using a formulation containing both a compound of formula (I) or pharmaceutically acceptable salt of ester thereof and a selective COX-2 inhibitor, or the active ingredients may be administered intravenously using separate formulations for each active ingredient already known in the art, i.e. one formulation containing a compound of formula (I) or pharmaceutically acceptable salt of ester thereof and the other formulation containing a selective COX-2 inhibitor.

Oral Administration

Pharmaceutical formulations suitable for oral administration, and which may contain a solid carrier, may be presented as unit dose formulations such as boluses, capsules or tablets each containing a predetermined amount of the active ingredient(s).

A tablet may be made by compression or moulding, optionally with one or more accessory ingredients. Compressed tablets may be prepared by compressing in a suitable machine the active compound(s) in a free-flowing form such as a powder or granules optionally mixed with a binder, lubricant, inert diluent, lubricating agent, surface-active agent or dispersing agent. Moulded tablets may be made by moulding an inert liquid diluent. Tablets may be optionally coated and, if uncoated, may optionally be scored.

Capsules may be prepared by filling the active ingredient(s), either alone or in admixture with one or more accessory ingredients, into the capsule shells and then sealing them in the usual manner. Cachets are analogous to capsules wherein the active ingredient(s) together with any accessory ingredient(s) are sealed in a rice paper envelope.

The compound of formula (I) or a pharmaceutically acceptable salt or ester thereof, the selective COX-2 inhibitor, or the combination of compound of formula (I) or a pharmaceutically acceptable salt or ester thereof and a selective COX-2 inhibitor compound, may also be formulated as dispersible granules, which may for example be suspended in water before administration, or sprinkled on food. The granules may be packaged, e.g. in a sachet.

Formulations suitable for oral administration wherein the carrier is a liquid may be presented as a solution or a suspension in an aqueous liquid or a non-aqueous liquid, or as an oil-in-water liquid emulsion.

Formulations for oral administration include controlled release dosage forms, e.g. tablets wherein the active ingredient(s) is/are formulated in an appropriate release—controlling matrix, or is/are coated with a suitable release—controlling film. Such formulations may be particularly convenient for prophylactic use.

Active ingredients according to the present invention include the compound of formula (I) and a selective COX-2 inhibitor compound. By way of example, the selective COX-2 inhibitor compound may be selected from a group comprising etoricoxib, parecoxib, celecoxib, valdecoxib and rofecoxib (also known as Arcoxia™, Dynastat™, Celebrex™, Bextra™ and Vioxx™, respectively).

The active ingredients may also be formulated as a solution or suspension suitable for administration via a naso-gastric tube.

Rectal Administration

Pharmaceutical formulations suitable for rectal administration, and which may contain a solid carrier, may be presented as unit dose suppositories. Suitable carriers include cocoa butter and other materials commonly used in the art. The suppositories may be conveniently formed by admixture of the active ingredient(s) with softened or melted carrier(s), diluent(s), adjuvant(s) or excipient(s) followed by chilling and shaping in suitable moulds.

Transdermal Administration

Pharmaceutical formulations adapted for transdermal administration may be provided as discrete patches intended to remain in intimate contact with the epidermis of the recipient for a prolonged period of time. For example, the active ingredient(s) may be delivered from the patch by iontophoresis (Iontophoresis is described in Pharmaceutical Research, 3(6): 318 (1986)).

Topical Administration

Pharmaceutical formulations adapted for topical administration may be provided as ointments, creams, suspensions, lotions, powders, solutions, pastes, gels, sprays, aerosols or oils. For topical administration to the skin, mouth, eye or other external tissues a topical ointment or cream is preferably used. When formulated in an ointment, the active ingredient(s) may be employed with either a paraffinic or a water-miscible ointment base. Alternatively, the active ingredient(s) may be formulated in a cream with an oil-in-water base or a water-in-oil base. Pharmaceutical formulations adapted for topical administration to the eye include eye drops. Here the active ingredient(s) can be dissolved or suspended in a suitable carrier, e.g. in an aqueous solvent. Pharmaceutical formulations adapted for topical administration in the mouth include lozenges, pastilles and mouthwashes.

Parenteral Administration

If the therapeutically active ingredients are administered parenterally, then examples of such administration include one or more of: intravenously, intra-arterially, intraperitoneally, intrathecally, intraventricularly, intraurethrally, intrasternally, intracranially, intramuscularly or subcutaneously administering the agent; and/or by using infusion techniques.

For parenteral administration, the active ingredient(s) may be used in the form of a sterile aqueous solution or in an oleaginous vehicle which may contain other substances, for example, enough salts or glucose to make the solution isotonic with blood. The aqueous solutions should be suitably buffered (preferably to a pH of from 3 to 9), if necessary. The preparation of suitable parenteral formulations under sterile conditions is readily accomplished by standard pharmaceutical techniques well-known to those skilled in the art.

Injectable preparations may be adapted for bolus injection or continuous infusion. Such preparations are conveniently presented in unit dose or multi-dose containers which are sealed after introduction of the formulation until required for use. Alternatively, the active ingredient(s) may be in powder form which are constituted with a suitable vehicle, such as sterile, pyrogen-free water, before use.

Transmucosal

“Transmucosal” refers to delivery of a drug into the blood stream such that the drug passes through the mucosal tissue and enters into the blood stream.

Transurethral or Intraurethral

“Transurethral” or “intraurethral” refers to delivery of a drug into the urethra, such that the drug contacts and passes through the wall of the urethra and enters into the blood stream.

Blood Brain Barrier (BBB)

Within the scope of the present invention, a pharmaceutical formulation may be designed to pass across the blood brain barrier (BBB). For example, a carrier such as a fatty acid, inositol or cholesterol may be selected that is able to penetrate the BBB. The carrier may be a substance that enters the brain through a specific transport system in brain endothelial cells, such as insulin-like growth factor I or II. The carrier may be coupled to the active agent or may contain/be in admixture with the active agent Liposomes can be used to cross the BBB. WO 91/04014 describes a liposome delivery system in which an active agent can be encapsulated/embedded and in which molecules that are normally transported across the BBB (e.g. insulin or insulin-like growth factor I or II) are present on the liposome outer surface. Liposome delivery systems are also discussed in U.S. Pat. No. 4,704,355. Accordingly, the pharmaceutical formulations can be encapsulated/embedded into a delivery vehicle such as a liposome in order for the therapeutically active ingredient(s) to be able to cross the BBB.

The formulations may be specifically modulated to comprise a brain targeting moiety, such as an anti-insulin receptor antibody (Coloma et al., (2000) Pharm Res 17:266-74), anti-transferrin receptor antibodies (Zhang and Pardridge, (2001) Brain res 889:49-56) or activated T-cells (Westland et al., (1999) Brain 122:1283-91).

Alternatively, techniques resulting in modification of the vasculature by the use of vasoactive peptides such as bradykinin or other techniques such as osmotic shock (reviewed in Begley, (1996) J Pharm Pharmacol 48:136-46; Neuwelt et al., (1987) Neurosurgery 20:885-95; Kroll et al, (1998) Neurosurgery 43:879-86; Temsamani et al., (2000) Pharm Sci Technol Today 3:155-162) may be employed.

The provision of pharmaceutical formulations that are capable of crossing the BBB can potentially enable the treatment of brain tumours.

Long-Acting Depot Preparation

The compound of formula (I) or a pharmaceutically acceptable salt or ester thereof, the selective COX-2 inhibitor, or the combination of compound of formula (I) or a pharmaceutically acceptable salt or ester thereof and a selective COX-2 inhibitor compound, may also be formulated as a long-acting depot preparation, which may be administered by intramuscular injection or by implantation e.g. subcutaneously or intramuscularly. Depot preparations may include, for example, suitable polymeric or hydrophobic materials, or ion-exchange resins. Such long-acting formulations are particularly convenient for prophylactic use.

Carriers, Diluents, Excipients and Adjuvants

“Carriers, diluents, excipients and adjuvants” refers to materials suitable for compound administration and include any such material known in the art such as, for example, any liquid, gel, solvent, liquid diluent, solubilizer, or the like, which is non-toxic and which does not interact with any components of the formulation in a deleterious manner.

Examples of pharmaceutically acceptable carriers, diluents, excipients and adjuvants include but are not limited to for example, water, salt solutions, alcohol, silicone, waxes, petroleum jelly, vegetable oils, polyethylene glycols, propylene glycol, liposomes, sugars, gelatin, lactose, amylose, magnesium stearate, talc, surfactants, silicic acid, viscous paraffin, perfume.

It should be understood that in addition to the aforementioned carrier, diluent, excipient and/or adjuvant ingredients the pharmaceutical formulations for the various routes of administration described above may include, as appropriate one or more additional carrier, diluent, excipient and/or adjuvant ingredient such as pH buffering agents, emulsifying agents, flavouring agents, binders, surface active agents, thickeners, lubricants, preservatives (including anti-oxidants) and the like, and substances included for the purpose of rendering the formulation isotonic with the blood of the intended recipient.

The pharmaceutical formulation(s) may, for example, comprise an adjuvant selected from mineral gels (e.g., aluminum hydroxide), surface active substances such as lysolecithin, pluronic polyols, polyanions, peptides, oil emulsions, alum, and MDP.

Generally, the formulation(s) are supplied either separately or mixed together in unit dosage form, for example, as a dry lyophilized powder or water free concentrate in a hermetically sealed container such as an ampoule or sachette indicating the quantity of active ingredient(s) Where the formulation(s) is administered by injection, an ampoule of sterile diluent can be provided so that the ingredients may be mixed prior to administration.

In a specific embodiment, a pharmaceutical formulation(s) is provided in a first container; a second container comprises diluent consisting of an aqueous solution of 50 t glycerin, 0.25 t phenol, and an antiseptic (e.g., 0.005-i5 brilliant green).

The active ingredient(s) of the pharmaceutical formulation(s) described herein can be mixed with excipients which are pharmaceutically acceptable and compatible with the active ingredient(s). Suitable excipients are, for example, water, saline, dextrose, glycerol, ethanol, or the like and combinations thereof.

Compounds of formula (I) and (II) may be prepared by methods known in the art. For example, compounds of formula (I), wherein R₁, R₂, R₃, and R₄, are as defined in part (b) of the definition of formula (I) as recited above, may be prepared using the methods as disclosed in U.S. Pat. No. 4,602,034 (Briet et al.,), the contents of which are herein incorporated by reference.

Compounds of formula (III), (IV) and (V) are known and may be prepared using the methods known in the art. For example, compounds of formula (III), (IV) and (V) and their preparation are described in the following references, the contents of which are herein incorporated by reference:

Rewcastle et al, Journal of Medicinal Chemistry 34(1): 217-22, January 1991;

Rewcastle et al, Journal of Medicinal Chemistry 34(2): 491-6, February 1991;

Atwell et al, Journal of Medicinal Chemistry 33(5): 1375-9, May 1990;

Rewcastle et al, Journal of Medicinal Chemistry 34(9): 2864-70, September 1991;

Rewcastle et al, Journal of Medicinal Chemistry 32(4): 793-9, April 1989

DMXAA may be prepared according to the methods described in Rewcastle et al, Journal of Medicinal Chemistry 34(1): 217-22, January 1991, the contents of which are incorporated herein by reference.

The selective COX-2 inhibitor(s) as described herein may be prepared by any suitable method known to the skilled person. For example, rofecoxib (Vioxx™) is a well known compound and can be prepared by methods known to those skilled in the art.

It is to be understood that the present invention covers all combinations of suitable and preferred groups described hereinabove.

### BRIEF DESCRIPTION OF THE FIGURES

FIG. 1. Shows a tumour growth delay curve over time following a course of treatment with DMXAA (25 mg/kg, square), Vioxx™ (150 mg/kg, triangle), the combination of DMXAA (25 mg/kg) and Vioxx™ (100 mg/kg, inverse triangle), the combination DMXAA (25 mg/kg) and Vioxx™ (150 mg/kg, diamond), and control (circle). Mean±SEM of 6 mice per time point.

The present invention will now be illustrated, but is not intended to be limited, by means of the following examples.

### EXAMPLES

Materials and Methods

C57B1/6 mice from the Animal Resource Unit, University of Auckland, were bred and housed under conditions of constant temperature and humidity, with sterile bedding and food, according to institutional ethical guidelines. All mice were aged between 8 and 12 weeks.

Drugs and Drug Administration

DMXAA was synthesized as the sodium salt (Rewcastle et al., (1990) Journal of National Cancer Institute 82:528-529). DMXAA sodium salt was dissolved in neutral aqueous solution and 25 mg/kg, in a volume of 0.1 ml per 10 g body weight, was injected intraperitoneally (i.p.) into mice.

Vioxx™ (Sigma) was made up in neutral aqueous solution and 100 or 150 mg/kg, in a volume of 0.1 ml per 10 g body weight, was injected intraperitoneally (i.p.) into mice. When administered with DMXAA, the required dose of Vioxx™ was injected concurrently with the DMXAA.

Tumour Growth Delay Assay

Colon 38 tumour fragments (˜1 mm³) were implanted subcutaneously (s.c.) in anaesthetized (sodium pentobarbitone, 90 mg/kg) mice. The experiments were initiated approximately 8 days later when tumours were approximately 60 mm³ in size. Tumour-bearing mice were treated with drugs according to the administration schedule described before, and the tumours measured using calipers, at three day intervals thereafter. Tumour volumes were calculated as 0.52a²b, where a and b are the minor and major axes of the tumour, respectively. The arithmetic means were calculated for each time point, counting cured tumours as zero volume. The growth delay was determined as the difference in the number of days required for the control versus treated tumours to increase four times in volume.

### Example 1

### Tumour Growth Delay

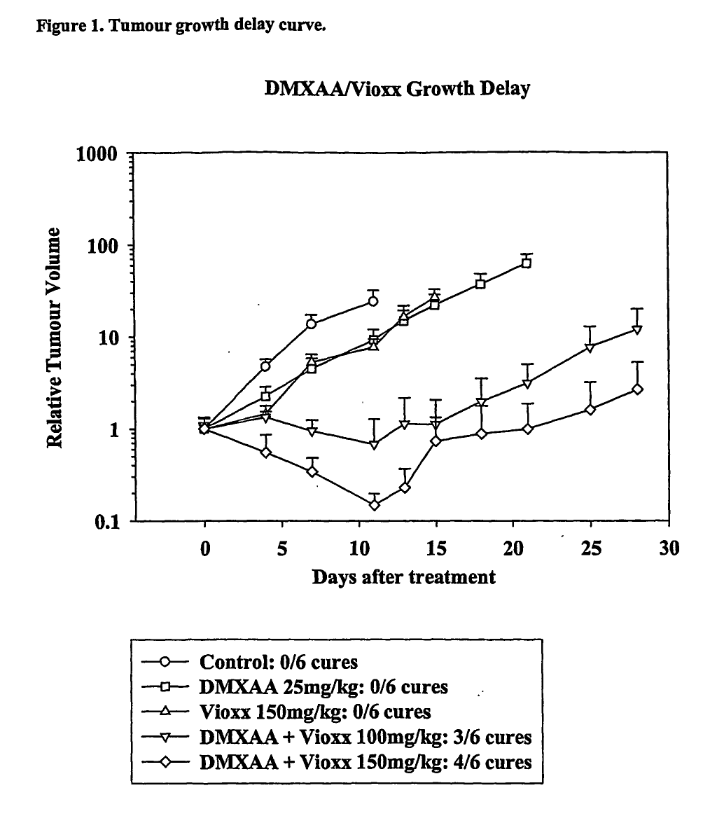

The tumour growth delay experiment, against colon 38 tumours implanted s.c. in mice, was conducted using 5 drug regimes: 1) untreated controls, 2) DMXAA alone (25 mg/kg), 3) Vioxx™ alone (150 mg/kg), 4) a combination group of DMXAA (25 mg/kg)+Vioxx™ (100 mg/kg) and 5) a combination group of DMXAA (25 mg/kg)+Vioxx™ (150 mg/kg). The results are shown in FIG. 1.

Vioxx™ alone was found to have no significant effect on the growth of colon 38 tumours. None of the mice treated with DMXAA were cured. With the combination group, there was a remarkable improvement in the antitumour response in that at the combination group of DMXAA (25 mg/kg)+Vioxx™ (100 mg/kg) three out of 6 (3/6) were cured, while in the a combination group of DMXAA (25 mg/kg)+Vioxx™ (150 mg/kg) four out of 6 (4/6) were cured. The results showed that coadministration of Vioxx™ with DMXAA can lead to significant increases in antitumour activity.

Discussion

In this study, it had been shown that in mice a selective COX-2 inhibitor, in particular rofecoxib (Vioxx™) at 100 mg/kg or 150 mg/kg could enhance the DMXAA anti-tumour activity (FIG. 1). DMXAA monotherapy showed no cure, whereas for DMXAA combination therapy, there was a significant increase in the number of cures. These results suggest that by coadministration of rofecoxib, the anti-tumour activity of DMXAA can be increased.

Each of the applications and patents mentioned in this document, and each document cited or referenced in each of the above applications and patents, including during the prosecution of each of the applications and patents (“application cited documents”) and any manufacturer's instructions or catalogues for any products cited or mentioned in each of the applications and patents and in any of the application cited documents, are hereby incorporated herein by reference. Furthermore, all documents cited in this text, and all documents cited or referenced in documents cited in this text, and any manufacturer's instructions or catalogues for any products cited or mentioned in this text, are hereby incorporated herein by reference.

Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in molecular biology or related fields are intended to be within the scope of the claims.

1. A method for modulating neoplastic growth, which comprises administering to a mammal, including a human, in need of treatment an effective amount of a compound of formula (I): 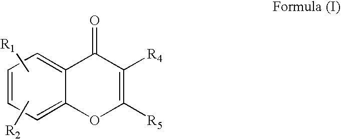
or a pharmaceutically acceptable salt or ester thereof and simultaneously, separately or sequentially administering an effective amount of a selective COX-2 inhibitor, wherein said effective amount of said inhibitor is an amount which enhances the effectiveness of the compound having the formula (I) as defined above to function as an anti-tumour agent in said mammal;
wherein:
(a) R₄ and R₅ together with the carbon atoms to which they are joined, form a 6-membered aromatic ring having a substituent —R₃ and a radical —(B)—COOH where B is a linear or branched substituted or unsubstituted C₁-C₆ alkyl radical, which is saturated or ethylenically unsaturated, and wherein R₁ R₂ and R₃ are each independently selected from the group consisting of H, C₁-C₆ alkyl, halogen, CF₃, CN, NO₂, NH₂, OH, OR, NHCOR, NHSO₂R, SR, SO₂R or NHR, wherein each R is independently C₁-C6 alkyl optionally substituted with one or more substituents selected from hydroxy, amino and methoxy; or
(b) one of R₄ and R₅ is H or a phenyl radical, and the other of R₄ and R₅ is H or a phenyl radical which may optionally be substituted, thienyl, furyl, naphthyl, a C₁-C₆ alkyl, cycloalkyl, or aralkyl radical; R₁ is H or a C₁-C₆ alkyl or C₁-C₆ alkoxy radical; R₂ is the radical —(B)—COOH where B is a linear or branched substituted or unsubstituted C₁-C₆ alkyl radical, which is saturated or ethylenically unsaturated.

2. The method according to claim 1 wherein the compound of Formula (I) is a compound of Formula (II): 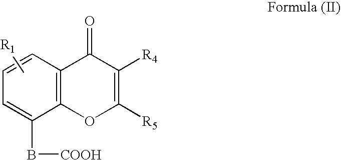
where R₁, R₄, R₅ and B are as defined for formula (I) in claim 1 part (b).

3. The method according to claim 1 wherein the compound of Formula (I) is a compound of Formula (III): 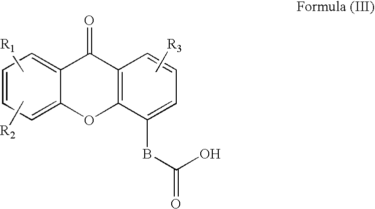
wherein R₁, R₂ and R₃ are each independently selected from the group consisting of H, C₁-C₆alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy;
wherein B is as defined for formula (I) in claim 1;
and wherein in each of the carbocyclic aromatic rings in formula (I), up to two of the methine (—CH═) groups may be replaced by an aza (—N═) group;
and wherein any two of R₁, R₂ and R₃ may additionally together represent the group —CH═CH—CH═CH—, such that this group, together with the carbon or nitrogen atoms to which it is attached, forms a fused 6 membered aromatic ring.

4. The method according to claim 3, wherein the compound of Formula (I) is a compound of Formula (IV): 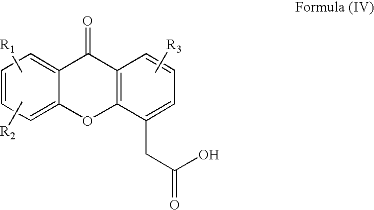
wherein R, R₁, R₂ and R₃ are as defined for formula (III) in claim 3.

5. A method according to claim 4 wherein the compound of Formula (IV) is a compound of formula (V): 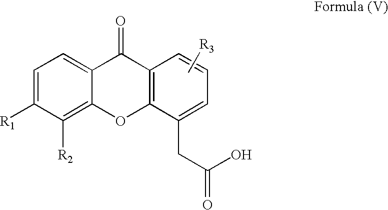
wherein R, R₁, R₂ and R₃ are as defined for formula IV in claim 4.

6. A method for modulating neoplastic growth, which comprises administering to a mammal, including a human, in need of treatment an effective amount of a compound of formula (I): 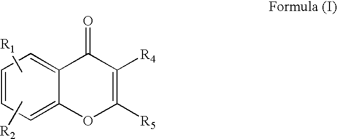
or a pharmaceutically acceptable salt or ester thereof and simultaneously, separately or sequentially administering an effective amount of a selective COX-2 inhibitor, wherein said effective amount of said inhibitor is in the range of greater than 5 and up to 200 mg/kg which enhances the effectiveness of the compound having the formula (I) as defined above to function as an anti-tumour agent in said mammal;
wherein:
(a) R₄ and R₅ together with the carbon atoms to which they are joined, form a 6-membered aromatic ring having a substituent —R₃ and a radical —(B)—COOH where B is a linear or branched substituted or unsubstituted C₁-C₆ alkyl radical, which is saturated or ethylenically unsaturated, and wherein R₁, R₂ and R₃ are each independently selected from the group consisting of H, C₁-C₆ alkyl, halogen, CF₃, CN, NO₂, NH₂, OH, OR, NHCOR, NHSO₂R, SR, SO₂R or NHR, wherein each R is independently C₁-C₆ alkyl optionally substituted with one or more substituents selected from hydroxy, amino and methoxy; or
(b) one of R₄ and R₅ is H or a phenyl radical, and the other of R₄ and R₅ is H or a phenyl radical which may optionally be substituted, thenyl, furyl, naphthyl, a C₁-C₆ alkyl, cycloalkyl, or aralkyl radical; R₁ is H or a C₁-C₆ alkyl or C₁-C₆ alkoxy radical; R₂ is the radical —(B)—COOH where B is a linear or branched substituted or unsubstituted C₁-C₆ alkyl radical, which is saturated or ethylenically unsaturated.

7. A method according to claim 6 wherein said effective amount of said inhibitor is in the range of 50-200 mg/kg which enhances the effectiveness of the compound having the formula (I) to function as an anti-tumour agent in said mammal.

8. The method according to claim 1 wherein R₄ is H or a phenyl radical, R₅ is H or a phenyl radical which may optionally be substituted, thienyl, furyl, naphthyl, a C₁-C₆ alkyl, cycloalkyl, or aralkyl radical; R₁ is H or a C₁-C₆ alkyl or C₁-C₆ alkoxy radical; R₂ is radical —(B)—COOH where B is a linear or branched substituted or unsubstituted C₁-C₆ alkyl radical, which is saturated or ethylenically unsaturated.

9. A method according to claim 1, wherein the compound of Formula (I) is DMXAA.

10. A method according to claim 1 wherein the compound of formula (I) or pharmaceutically acceptable salt or ester thereof and the selective COX-2 inhibitor are administered in a potentiating ratio.

11. A method according to any one of the preceding claims wherein the compound of formula (I) or pharmaceutically acceptable salt or ester thereof and the selective COX-2 inhibitor are administered simultaneously.

12. A method according to claim 1 wherein the compound of formula (I) or pharmaceutically acceptable salt or ester thereof and the selective COX-2 inhibitor axe administered sequentially.

13. The method according to claim 1 wherein the selective COX-2 inhibitor is selected from the group comprising etoricoxib, parecoxib, celecoxib, valdecoxib and rofecoxib.

14. The method according to claim 13 wherein the selective COX-2 inhibitor rofecoxib.

15. The method according to claim 1 wherein the method is for modulation of neoplastic growth in colon cancer.

16. A method according to claim 1 wherein the compound of formula (I) and the selective COX-2 inhibitor are administered to a patient while the patient is undergoing other forms of treatment.

17. A method according to claim 16 wherein the other forms of treatment include treatment with steroids, corticosteroids, antibiotics, antiviral therapy, immunosuppresants and anti-inflammatories.

18. Use of a compound of formula (I) as defined in claim 1 or a pharmaceutically acceptable salt or ester thereof for the manufacture of a medicament, for simultaneous, separate or sequential administration with a unit dose of a selective COX-2 inhibitor, for the modulation of neoplastic growth, wherein said unit dose comprises said inhibitor in an amount which enhances the effectiveness of the compound having the formula (I) to function as an anti-tumour agent in said mammal.

19. Use of a selective COX-2 inhibitor for the manufacture of a unit dose of a medicament, for simultaneous, separate or sequential administration with a compound of formula (I) as defined in claim 1 or a pharmaceutically acceptable salt or ester thereof, for the modulation of neoplastic growth, wherein said unit dose comprises said inhibitor in an amount which enhances the effectiveness of the compound having the formula (I) to function as an anti-tumour agent in a subject to be treated.

20. Use according to claim 18 wherein the selective COX-2 inhibitor is selected from the group comprising etoricoxib, parecoxib, celecoxib, valdecoxib and rofecoxib.

21. Use according to claim 20 wherein the selective COX-2 inhibitor compound is rofecoxib.

22. Use according to claim 18 wherein the compound of formula (I) or pharmaceutically acceptable salt or ester thereof and the selective COX-2 inhibitor are present in a potentiating ratio.

23. Use according to claim 22 wherein the ratio of compound of formula (I):selective COX-2 inhibitor is in the-range 1:10 to 1:1.

24. Use according to claim 23 wherein the ratio of compound of formula (I):selective COX-2 inhibitor is about 1:6.

25. Use according to claim 18 wherein the compound of formula (I) or pharmaceutically acceptable salt or ester thereof and the selective COX-2 inhibitor are administered simultaneously.

26. Use according to claim 18 wherein the compound of formula (I) or pharmaceutically acceptable salt or ester thereof and the selective COX-2 inhibitor are administered sequentially.

27. Use according to claim 18 wherein the compound of formula (I) is DMXAA.

28. A pharmaceutical formulation comprising a combination of the compound of formula (I) as defined in claim 1 or a pharmaceutically acceptable salt or ester thereof and a selective COX-2 inhibitor compound, wherein a unit dose of said pharmaceutical formulation comprises said selective COX-2 inhibitor compound in an amount which enhances the effectiveness of the compound of formula (I) to function as an anti-tumour agent in a subject to be treated.

29. A pharmaceutical formulation according to claim 28 wherein the formulation is adapted for intravenous administration.

30. A pharmaceutical formulation according to claim 28 wherein the selective COX-2 inhibitor is selected from the group comprising etoricoxib, parecoxib, celecoxib, valdecoxib and rofecoxib.

31. A pharmaceutical formulation according to claim 28 wherein the selective COX-2 inhibitor is rofecoxib.

32. A pharmaceutical formulation according to claim 28 wherein the compound of formula (I) is DMIXAA.

33. A process for the preparation of a pharmaceutical formulation which process comprises bringing into association a combination of a compound of formula (I) as defined in claim 1 or a pharmaceutically acceptable salt or ester thereof and a selective COX-2 inhibitor optionally with one or more pharmaceutically acceptable carriers, excipients, diluents or adjuvants therefor wherein said unit dose comprises said inhibitor in an amount which enhances the effectiveness of the compound having the formula (I) to function as an anti-tumour agent in a subject to be treated.

34. A process according to claim 33 wherein the selective COX-2 inhibitor is selected from the group comprising etoricoxib, parecoxib, celecoxib, valdecoxib and rofecoxib.

35. A process according to claim 34 wherein the selective COX-2 inhibitor is rofecoxib.

36. A process according to claim 33 wherein the compound of formula (I) is DMXAA.

37. A kit comprising in combination for simultaneous, separate or sequential modulating neoplastic growth, a compound of formula (I) as defined in claim 1 or a pharmaceutically acceptable salt or ester thereof and a selective COX-2 inhibitor, wherein said inhibitor is provided in a unit dose comprising an amount of a selective COX-2 inhibitor which enhances the effectiveness of the compound of formula (I) to function as an anti-tumour agent in a subject to be treated.

38. A kit for simultaneous, separate or sequential use in modulating neoplastic growth, wherein the kit contains two components:
iii) The first component comprises a compound of formula (I) as defined in claim 1 or a pharmaceutically acceptable salt or ester thereof and
iv) The second component comprises a selective COX-2 inhibitor,
wherein said second component is provided in a unit dose comprising the selective COX-2 inhibitor in an amount which is least that required to enhance the effectiveness of the compound of formula (I) as defined above or a pharmaceutically acceptable salt or ester thereof to function as an anti-tumour agent in a subject to be treated.

39. A kit according to claim 37 wherein the selective COX-2 inhibitor is selected from the group comprising etoricoxib, parecoxib, celecoxib, valdecoxib and rofecoxib.

40. A kit according to claim 37 wherein the selective COX-2 inhibitor is rofecoxib.

41. A kit according to claim 40 wherein the compound of formula (I) is DMXAA.

42. A method, a use, a pharmaceutical formulation, a process or a kit substantially as described herein and with reference to the Examples.
